(19) United States
(12) Patent Application Publication
(10) Pub. No.: US 2025/0274849 A1
(43) Pub. Date: Aug. 28, 2025

(54) Wireless communication circuit and channel scanning method thereof

(71) Applicant: REALTEK SEMICONDUCTOR CORPORATION, Hsinchu (TW)

(72) Inventors: CHUN-CHUAN CHEN, Hsinchu (TW); Yu-Hsuan CHIU, Hsinchu (TW)

(21) Appl. No.: 19/052,966

(22) Filed: Feb. 13, 2025

(30) Foreign Application Priority Data
Feb. 22, 2024 (TW) 113106454

(51) Int. Cl. H04W 48/16

(52) U.S. Cl. CPC H04W 48/16

(57) ABSTRACT

A wireless communication circuit includes multiple pairs of antennas, a first media access control (MAC) circuit, a second MAC circuit, a switch circuit, and a control circuit. The switch is used to couple the pairs of antennas to the first MAC circuit or the second MAC circuit. The control circuit is configured to perform the following steps: controlling the first MAC circuit to scan a first channel list; controlling the second MAC circuit to scan a second channel list; and controlling the first MAC circuit to scan a third channel list

### BACKGROUND OF THE INVENTION

### 1. Field of the Invention

The present invention generally relates to wireless communication, and, more particularly, to a wireless communication circuit and its channel scanning method.

### 2. Description of Related Art

In wireless communication systems (e.g., wireless networks (Wi-Fi), Bluetooth, etc.), scanning is a necessary operation for a station (e.g., a mobile phone, a computer, a television, etc.). The purpose of the scanning is to search for available access points (AP). However, the scanning not only increases the power consumption of the station but also may affect the signal quality of the active link (i.e., the link that is currently utilized for transmission). Therefore, a more flexible scanning mechanism is needed to enhance the performance of the station.

### SUMMARY OF THE INVENTION

In view of the issues of the prior art, an object of the present invention is to provide a wireless communication circuit and its channel scanning method, so as to make an improvement to the prior art.

According to one aspect of the present invention, a wireless communication circuit is provided. The wireless communication circuit includes a plurality of pairs of antennas; a first media access control (MAC) circuit; a second MAC circuit; a switch circuit coupled to the plurality of pairs of antennas, the first MAC circuit, and the second MAC circuit, and configured to couple the plurality of pairs of antennas to the first MAC circuit or the second MAC circuit; and a control circuit coupled to the plurality of pairs of antennas, the first MAC circuit, the second MAC circuit, and the switch circuit, and configured to perform the following steps: controlling the first MAC circuit to scan a first channel list; controlling the second MAC circuit to scan a second channel list; and controlling the first MAC circuit to scan a third channel list after the first MAC circuit has scanned all channels in the first channel list.

According to another aspect of the present invention, a wireless communication circuit is provided. The wireless communication circuit includes a plurality of pairs of antennas; a first media access control (MAC) circuit; a second MAC circuit; a switch circuit coupled to the plurality of pairs of antennas, the first MAC circuit, and the second MAC circuit, and configured to couple the plurality of pairs of antennas to the first MAC circuit or the second MAC circuit; and a control circuit coupled to the plurality of pairs of antennas, the first MAC circuit, the second MAC circuit, and the switch circuit, and configured to perform the following steps: controlling the first MAC circuit to serve as an active link; and controlling the second MAC circuit to sequentially scan a first channel list, a second channel list, and a third channel list, wherein the first channel list and the second channel list are of a same frequency band, or the second channel list and the third channel list are of a same frequency band.

The technical means embodied in the embodiments of the present invention can solve at least one of the problems of the prior art. Therefore, compared to the prior art, the present invention can reduce power consumption and enhance user experience.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1A is a functional block diagram of a wireless communication circuit according to an embodiment of the present invention.

FIG. 1B is a functional block diagram of the wireless communication circuit according to another embodiment of the present invention.

FIGS. 2A to 2C are flowcharts of the channel scanning method according to an embodiment of the present invention.

FIG. 3 is a schematic diagram of scanning channel according to an embodiment of the present invention.

FIG. 4 is a flowchart of the channel scanning method according to another embodiment of the present invention.

FIG. 5 is a schematic diagram of scanning channel according to another embodiment of the present invention.

FIG. 6 is a flowchart of the channel scanning method according to another embodiment of the present invention.

FIG. 7A is a schematic diagram of scanning channel according to another embodiment of the present invention.

FIG. 7B is a schematic diagram of scanning channel according to another embodiment of the present invention.

FIG. 8 is a flowchart of the channel scanning method according to another embodiment of the present invention.

FIG. 9A is a schematic diagram of scanning channel according to another embodiment of the present invention.

FIG. 9B is a schematic diagram of scanning channel according to another embodiment of the present invention.

FIG. 10 shows the sub-steps of step S860 of FIG. 8.

FIG. 11 is a schematic diagram of scanning channel according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a wireless communication circuit and its channel scanning method. On account of that some or all elements of the wireless communication circuit could be known, the detail of such elements is omitted provided that such detail has little to do with the features of this disclosure, and that this omission nowhere dissatisfies the specification and enablement requirements. Some or all of the processes of the channel scanning method may be implemented by software and/or firmware and can be performed by the wireless communication circuit or its equivalent. A person having ordinary skill in the art can choose components or steps equivalent to those described in this specification to carry out the present invention, which means that the scope of this invention is not limited to the embodiments in the specification.

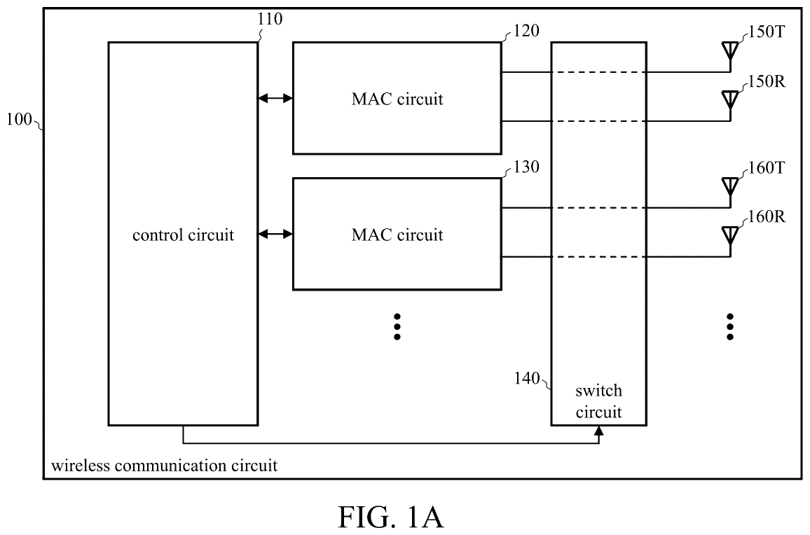

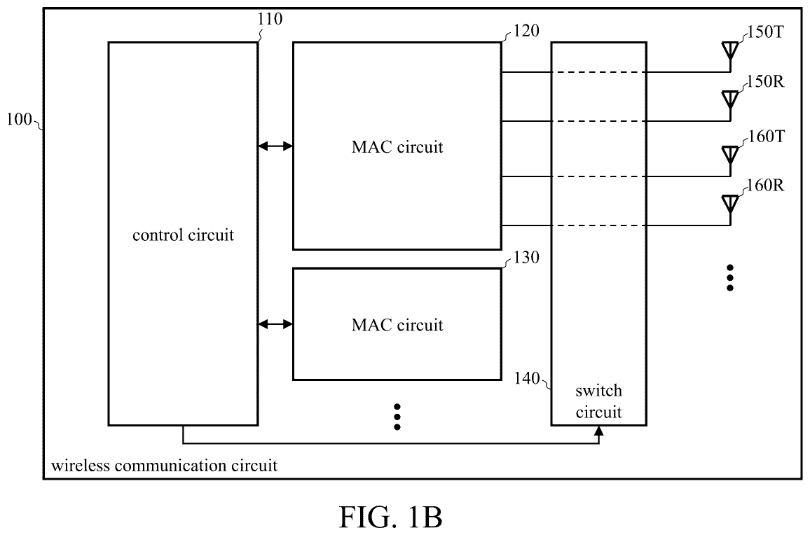

Reference is made to FIG. 1A, which is a functional block diagram of a wireless communication circuit according to an embodiment of the present invention. The wireless communication circuit 100 includes the control circuit 110, multiple media access control (MAC) circuits (including, but not limited to, the MAC circuit 120 and the MAC circuit 130), the switch circuit 140, and multiple pairs of antennas (including, but not limited to, the first pair of antennas composed of the antenna 150T and the antenna 150R and the second pair of antennas composed of the antenna 160T and the antenna 160R). Depending on the application scenario, a MAC circuit is coupled to one or more than one pair of antennas through the switch circuit 140, or is not coupled to any antenna. A pair of antennas includes a transmitting antenna and a receiving antenna. In the example of FIG. 1A, the MAC circuit 120 performs a scan or establishes connections with other devices through the antenna 150T and the antenna 150R, and the MAC circuit 130 performs a scan or establishes connections with other devices through the antenna 160T and the antenna 160R. The MAC circuit 120 and the MAC circuit 130 transmit data or the scan results to the control circuit 110.

Reference is made to FIG. 1B, which is a functional block diagram of a wireless communication circuit according to another embodiment of the present invention. In the example of FIG. 1B, the MAC circuit 120 performs a scan or establishes connections with other devices through the two transmitting antennas (e.g., the antenna 150T and the antenna 160T) and the two receiving antennas (e.g., the antenna 150R and the antenna 160R). The control circuit 110 can control the switch circuit 140 to switch the antennas according to the application scenario.

The wireless communication circuit 100 can support Wi-Fi, Bluetooth, or support both simultaneously. For example, when the wireless communication circuit 100 only supports Wi-Fi or Bluetooth, the MAC circuit 120 and the MAC circuit 130 are both MAC circuits for Wi-Fi or Bluetooth (i.e., following the specifications of Wi-Fi or Bluetooth). When the wireless communication circuit 100 simultaneously supports Wi-Fi and Bluetooth, the MAC circuit 120 is the Wi-Fi MAC circuit (i.e., following the Wi-Fi specification), the MAC circuit 130 is the Bluetooth MAC circuit (i.e., following the Bluetooth specification), and the antenna 150T, the antenna 150R, the antenna 160T, and the antenna 160R are shared by Wi-Fi and Bluetooth.

In recent years, Wi-Fi versions (e.g., Wi-Fi 6E) include the 2.4 GHz band, the 5 GHz band, and the 6 GHz band, and future Wi-Fi versions may include more bands. In recent years, the main frequency band of the Bluetooth versions (e.g., the version 5.3) is the 2.4 GHz band, while in the future, more frequency bands (e.g., the 5 GHz band and/or the 6 GHz band) may be included. In other words, the wireless communication circuit 100 must scan channels in multiple frequency bands.

The 5 GHz band of Wi-Fi includes the dynamic frequency selection (DFS) channels and the non-DFS channels. The 6 GHz band of Wi-Fi includes the preferred scanning channel (PSC) and the non-PSC.

In terms of scan time, all channels in the 2.4 GHz band, the non-DFS channels, and the PSC are static scan time, whereas the DFS channels are dynamic scan time.

With regard to the channel to be scanned, the channels to be scanned for the non-PSC are obtained through learning (i.e., a learning-type channel), while the other channels (including all the channels in the 2.4 GHz band, all the channels in the 5 GHz band, and the PSC) are non-learning-type channels. More specifically, non-PSC learns about all the channels to be scanned through the neighbor report (NR) and/or the reduced neighbor report (RNR) during the scanning process, whereas the non-learning-type channels know in advance all the channels to be scanned before scanning.

In the following embodiments, all channels in the 2.4 GHz band, non-DFS channels, PSC, DFS channels, and non-PSC are respectively referred to as the channel list CL0, the channel list CL1, the channel list CL2, the channel list CL3, and the channel list CL4. In other words, the channel lists CL0 to CL3 are the non-learned channel lists, and the channel list CL4 is the learned channel list. However, this is only an embodiment, and the present invention is not limited to this embodiment.

In the following embodiments, the default priority of the channel lists is: CL0, CL1, CL2, CL3, and CL4; in other words, the priority of non-learned channel lists is higher than the priority of the learned channel list. However, this is only an embodiment, and the present invention is not limited to this embodiment.

In the following embodiment, it is assumed that the wireless communication circuit 100 uses the MAC circuit 120 and/or the MAC circuit 130 to scan channels. However, in different embodiments, the wireless communication circuit 100 may use more (i.e., greater than 2) MAC circuits to scan channels.

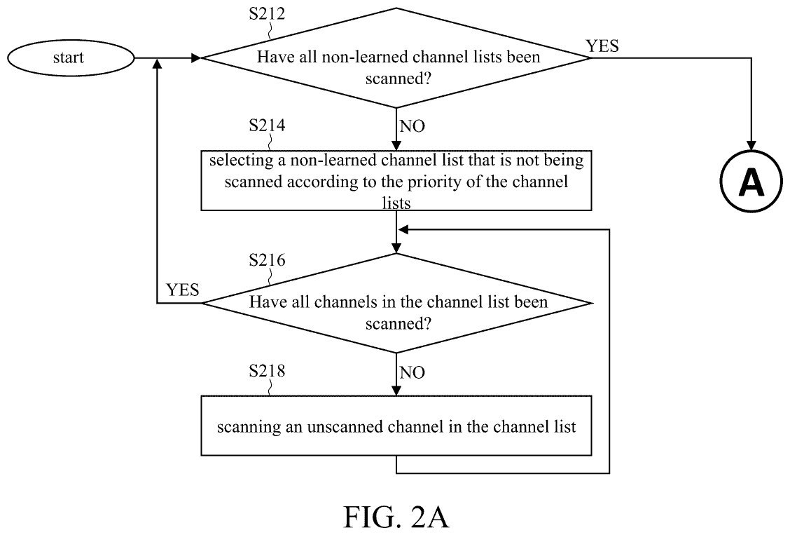

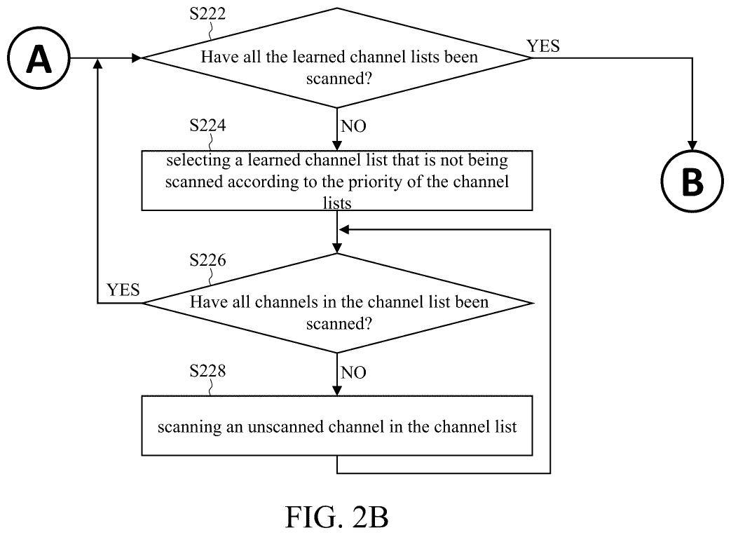

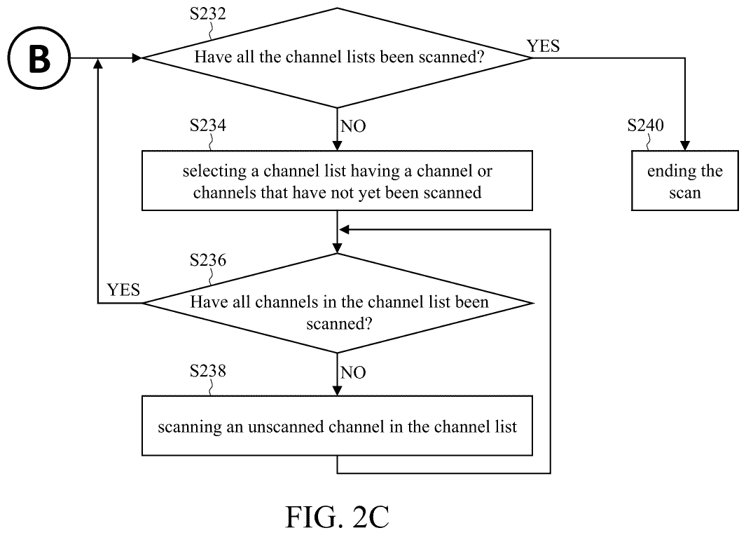

Reference is made to FIGS. 2A to 2C. FIGS. 2A to 2C are flowcharts of the channel scanning method according to an embodiment of the present invention. FIG. 2A includes the following steps.

Step S212: The control circuit 110 determines whether all non-learned channel lists have been scanned, that is, determines whether all channels in the channel lists CL0, CL1, CL2, and CL3 have been scanned. If YES, then proceed to the process of FIG. 2B; otherwise, perform step S214.

Step S214: The control circuit 110 selects a non-learned channel list that is not being scanned according to the default priority of the channel lists. For example, suppose only the channel list CL0 among the channel lists CL0 to CL3 has been scanned (i.e., all its channels have been scanned), and the MAC circuit 130 is scanning the channel list CL1. Then, the control circuit 110 selects the channel list CL2 according to the aforementioned default priority (instead of the channel list CL3, because the channel list CL2 has a higher priority) for the MAC circuit 120 to scan.

Step S216: The control circuit 110 determines whether all channels in the channel list (e.g., the channel list CL2 selected in step S214) have been scanned. If YES, then return to step S212; otherwise, perform step S218.

Step S218: The control circuit 110 controls the MAC circuit to scan an unscanned channel in the channel list (e.g., the channel list CL2 selected in step S214).

The control circuit 110 repeats steps S212 to S218 until all non-learned channel lists have been scanned, that is, until there is no unscanned non-learned channel list (the result of step S212 is YES). Next, the control circuit 110 executes the process of FIG. 2B, which includes the following steps.

Step S222: The control circuit 110 determines whether all the learned channel lists have been scanned. For example, the control circuit 110 determines in this step whether all channels of the channel list CL4 have been scanned. If YES, then proceed to the process of FIG. 2C; otherwise, perform step S224.

Step S224: The control circuit 110 selects a learned channel list that is not being scanned according to the default priority of the channel lists. Because in the aforementioned example, the learned channel list only includes the channel list CL4, only the channel list CL4 is available for selection in this step. However, in other embodiments, the learned channel list may include more types. Step S224 is similar to step S214, please refer to the discussion of step S214.

Step S226: This step is similar to step S216, please refer to the discussion of step S216.

Step S228: This step is similar to step S218, please refer to the discussion of step S218.

The control circuit 110 repeats steps S222 to S228 until all the learned channel lists have been scanned, that is, until there are no unscanned learned channel lists (the result of step S222 is YES). Next, the control circuit 110 executes the process of FIG. 2C, which includes the following steps.

Step S232: The control circuit 110 determines whether all the channel lists (including the learned channel list(s) and the non-learned channel list(s)) have been scanned. For example, the control circuit 110 determines whether all channels in the channel lists CL0 to CL4 have been scanned. If YES, perform step S240 (end the scan); otherwise, perform step S234.

Step S234: The control circuit 110 selects a channel list having a channel or channels that have not yet been scanned. For example, if only the channel list CL4 still has unscanned channel(s) (i.e., all channels in the channel lists CL0 to CL3 have been scanned), then regardless of whether the channel list CL4 is currently being scanned, the control circuit 110 selects the channel list CL4. In this way, in some situations, the control circuit 110 controls multiple MAC circuits to simultaneously scan the only remaining channel list that has not been completed, so as to speed up the scanning process (i.e., shorten the overall scan time).

Step S236: This step is similar to step S216, please refer to the discussion of step S216.

Step S238: This step is similar to step S218, please refer to the discussion of step S218.

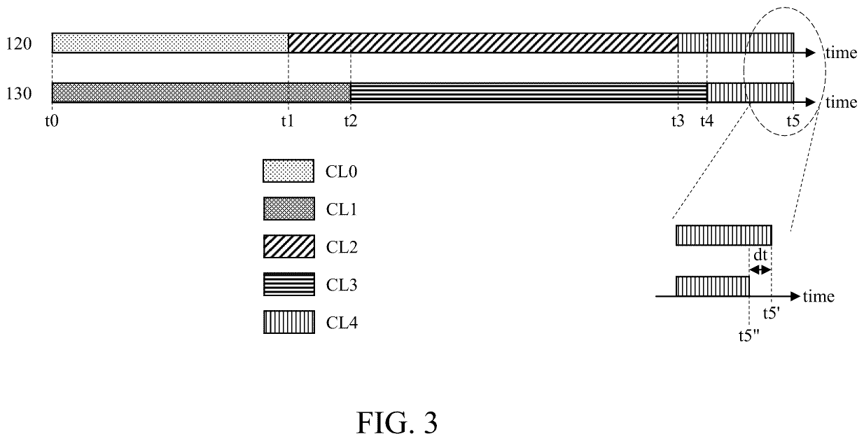

Reference is made to FIG. 3, which is a schematic diagram of scanning channel according to an embodiment of the present invention. FIG. 3 may correspond to the processes in FIGS. 2A to 2C. In the embodiment of FIG. 3, the wireless communication circuit 100 uses the MAC circuit 120 and the MAC circuit 130 to scan channels simultaneously, and the control circuit 110 assigns channels according to the channel scanning method of FIGS. 2A to 2C.

It should be noted that at the moment just before the start of scanning (i.e., the time point t0), the MAC circuit 120 and the MAC circuit 130 are inactive links.

More specifically, in the embodiments of FIGS. 2A to 2C and FIG. 3, the control circuit 110 does not use the active link for scanning. The following is discussion of the example in FIG. 3 in chronological order.

Time point t0: The scan begins, and the control circuit 110 controls the MAC circuit 120 and the MAC circuit 130 to scan the channel list CL0 and the channel list CL1, respectively (step S214).

Time point t0 to time point t1: The MAC circuit 120 and the MAC circuit 130 continue to scan the channel list CL0 and the channel list CL1, respectively (step S216 to step S218).

Time point t1: The MAC circuit 120 completes scanning all channels of the channel list CL0 (the result of step S216 is YES), then the control circuit 110 controls the MAC circuit 120 to scan the next channel list (step S214). Because at this time the channel list CL1 is being scanned by the MAC circuit 130, and the channel list CL0 has been scanned, the control circuit 110 controls the MAC circuit 120 to scan the channel list CL2.

Time point t1 to time point t2: The MAC circuit 120 and the MAC circuit 130 continue to scan the channel list CL2 and the channel list CL1, respectively (step S216 to step S218).

Time point t2: Similar to time point t1, at this time the control circuit 110 controls the MAC circuit 130 to scan the next channel list (i.e., the channel list CL3).

Time point t2 to time point t3: During this period, the MAC circuit 120 and the MAC circuit 130 continue to scan the channel list CL2 and the channel list CL3, respectively (step S216 to step S218).

Time point t3: The MAC circuit 120 completes scanning all the channels in the channel list CL2 (the result of step S216 is YES). Because at this time there is no unscanned non-learned channel list (i.e., the channel lists CL0, CL1, CL2, and CL3 have all been scanned or are being scanned, which means the result of step S212 is YES), the control circuit 110 subsequently controls the MAC circuit 120 to scan the channel list CL4 (step S224).

Time point t3 to time point t4: The MAC circuit 120 continues to scan the channel list CL4 (step S226 to step S228), and the MAC circuit 130 continues to scan the channel list CL3 (step S216 to step S218).

Time point t4: The MAC circuit 130 completes scanning all the channels in the channel list CL3 (the result of step S216 is YES). Because at this time there is no unscanned non-learned channel list and no unscanned learned channel list (since the channel list CL4 is being scanned, which means the results of step S212 and step S222 are both YES), the control circuit 110 subsequently controls the MAC circuit 130 to scan the channel list CL4 (step S234).

Time point t4 to time point t5: The MAC circuit 120 and the MAC circuit 130 both continue to scan the channel list CL4. That is to say, the MAC circuit 120 and the MAC circuit 130 simultaneously scan the same channel list.

Time point t5: The MAC circuit 120 and the MAC circuit 130 have completed scanning all channels of the channel list CL4 (step S236 is YES), and at this time, all the channel lists have been completely scanned (step S232 is YES). Next, the control circuit 110 ends the scan (step S240).

Reference is made to FIG. 3. The time point (t5′) at which the MAC circuit 120 actually ends scanning may be different from the time point (t5″) at which the MAC circuit 130 actually ends scanning. More specifically, during the period between time point t4 and time point t5 (when the MAC circuit 120 and the MAC circuit 130 simultaneously scan the channel list CL4), the control circuit 110 continuously assigns the unscanned channels in the channel list CL4 to the MAC circuit 120 or the MAC circuit 130 (step S236 to step S238). In this way, at the time point close to t5, one of the MAC circuit 120 and the MAC circuit 130 completes scanning first, while the other is just starting or is scanning the last channel of the channel list CL4. In other words, the time difference dt (=|t5′−t5″|) between the time point t5′ and the time point t5″ is less than or equal to the time required for the MAC circuit 120 (or 130) to scan one channel of the channel list CL4.

In summary, the channel scanning mechanism of the present invention uses multiple MAC circuits of the inactive links to perform scanning, and the time at which the multiple MAC circuits complete scanning is close or substantially the same, thereby shortening the overall scan time as much as possible. The shorter the scan time, the lower the power consumption. Low power consumption is crucial for mobile devices. The scan time required when using N MAC circuits is approximately 1/N of the scan time required when using a single MAC circuit, where N is an integer greater than 1.

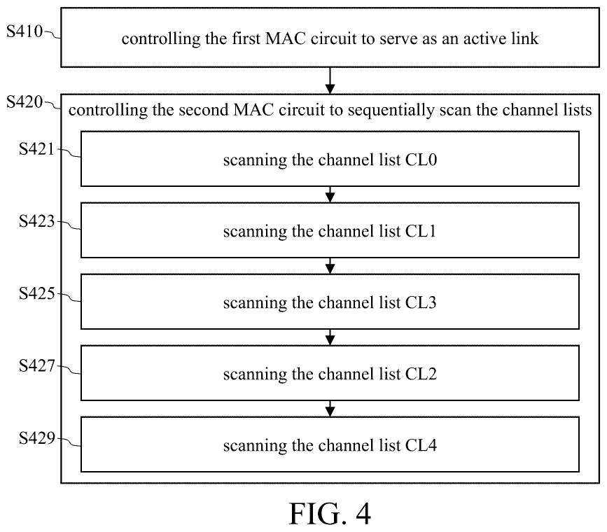

Reference is made to FIG. 4, which is a flowchart of the channel scanning method according to another embodiment of the present invention. FIG. 4 includes the following steps.

Step S410: The control circuit 110 controls the first MAC circuit (e.g., the MAC circuit 120) to serve as the active link. In other words, the wireless communication circuit 100 establishes a connection (e.g., for communication, data transmission/reception) with other devices (e.g., a wireless access point (WAP)) through the MAC circuit 120.

Step S420: The control circuit 110 controls the second MAC circuit (e.g., the MAC circuit 130) to sequentially scan the channel lists. Step S420 includes the following sub-steps.

Step S421: Scan the channel list CL0.

Step S423: Scan the channel list CL1.

Step S425: Scan the channel list CL3.

Step S427: Scan the channel list CL2.

Step S429: Scan the channel list CL4.

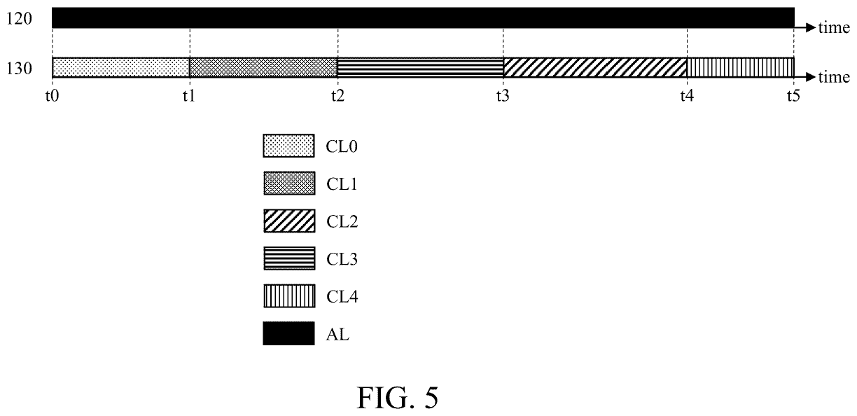

Reference is made to FIG. 5, which is a schematic diagram of scanning channel according to another embodiment of the present invention. FIG. 5 may correspond to the process of FIG. 4. The MAC circuit 120 (the first MAC circuit) is the active link (denoted as “AL”), and the MAC circuit 130 (the second MAC circuit) is the inactive link. In other words, in the embodiment of FIG. 5, the wireless communication circuit 100 only uses the MAC circuit 130 for scanning. As shown in the figure, the control circuit 110 controls the MAC circuit 130 to perform scanning according to the order of the channel lists CL0, CL1, CL3, CL2, and CL4. The advantage of scanning in this order is that the MAC circuit 130 does not need to switch frequency bands at time point t2 and time point t4 (more specifically, scanning only the 5 GHz frequency band throughout the period between time point t1 and time point t3, and scanning only the 6 GHz frequency band throughout the period between time point t3 and time point t5). Not switching frequency bands can reduce the time for the control circuit 110 to reconfigure the MAC circuit 130, improving the efficiency of scanning.

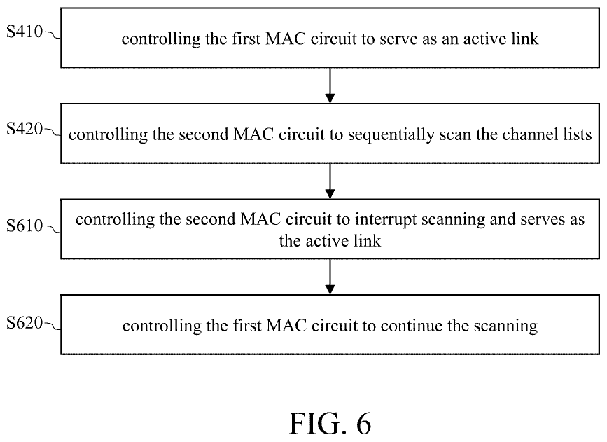

Reference is made to FIG. 6, which is a flowchart of the channel scanning method according to another embodiment of the present invention. In the embodiment of FIG. 6, the control circuit 110 performs step S610 and step S620 after step S420.

Step S610: The control circuit 110 controls the second MAC circuit to interrupt scanning and serves as the active link. More specifically, the control circuit 110 controls the second MAC circuit to interrupt scanning, and then the wireless communication circuit 100 establishes a connection with other devices through the second MAC circuit.

Step S620: The control circuit 110 controls the first MAC circuit to continue the scanning (that is, the first MAC circuit takes over the scanning from the second MAC circuit).

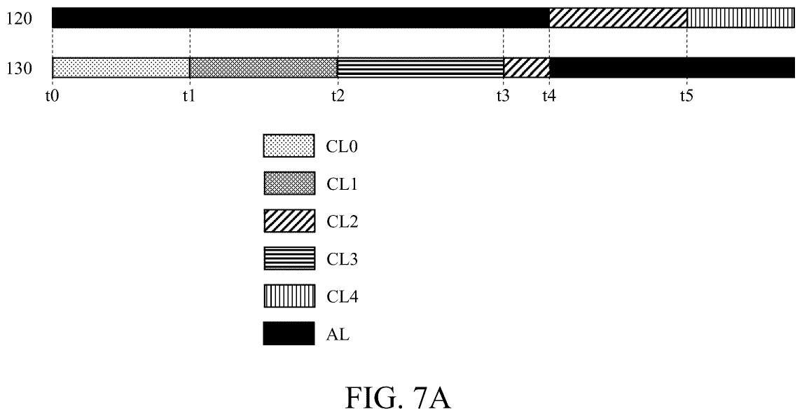

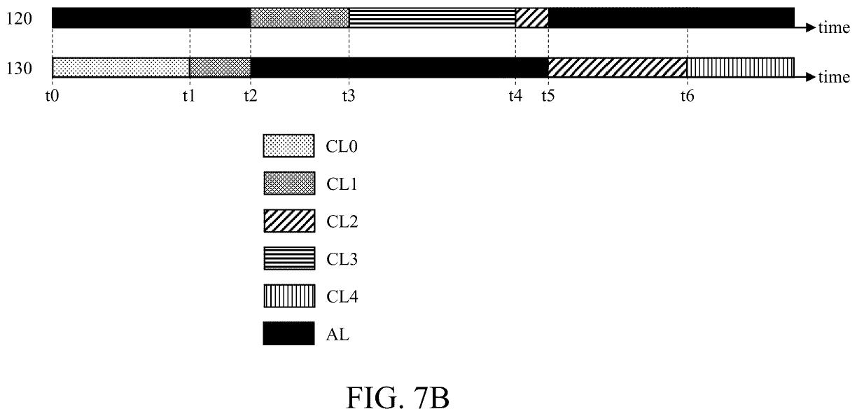

Reference is made to FIG. 7A, which is a schematic diagram of scanning channel according to another embodiment of the present invention. FIG. 7A may correspond to the process of FIG. 6. FIG. 7A is similar to FIG. 5, except that the wireless communication circuit 100 switches the active link from the MAC circuit 120 to the MAC circuit 130 at time point t4 (step S610). After the active link is switched, the control circuit 110 controls the inactive link to take over the scanning (e.g., the MAC circuit 120 takes over the scanning of the channel list CL3 at time point t4) (step S620).

Reference is made to FIG. 7B, which is a schematic diagram of scanning channel according to another embodiment of the present invention. FIG. 7B may correspond to the process of FIG. 6. FIG. 7B is similar to FIG. 7A, except that at time point t2, the wireless communication circuit 100 switches the active link from the MAC circuit 120 to the MAC circuit 130 (step S610), and at time point t5, the wireless communication circuit 100 switches the active link from the MAC circuit 130 to the MAC circuit 120 (step S610). Similarly, after the active link is switched, the control circuit 110 controls the inactive link to take over the scanning (step S620).

In summary, regardless of whether the active link is switched during the scanning process, since the active link is not used for scanning, the operations on the active link will not be affected by the scanning. This can ensure the performance of the wireless communication circuit 100 and enhance the user experience.

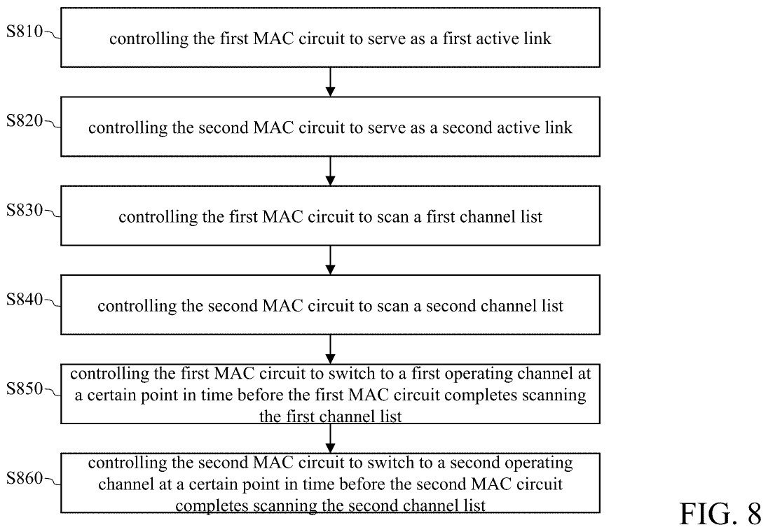

Reference is made to FIG. 8, which is a flowchart of the channel scanning method according to another embodiment of the present invention. FIG. 8 includes the following steps.

Step S810: The control circuit 110 controls the first MAC circuit to serve as a first active link.

Step S820: The wireless communication circuit 100 controls the second MAC circuit to serve as a second active link.

Step S830: The wireless communication circuit 100 controls the first MAC circuit to scan a first channel list.

Step S840: The control circuit 110 controls the second MAC circuit to scan a second channel list.

Step S850: At a certain point in time before the first MAC circuit completes scanning the first channel list, the control circuit 110 controls the first MAC circuit to switch to a first operating channel.

Step S860: At a certain point in time before the second MAC circuit completes scanning the second channel list, the control circuit 110 controls the second MAC circuit to switch to a second operating channel.

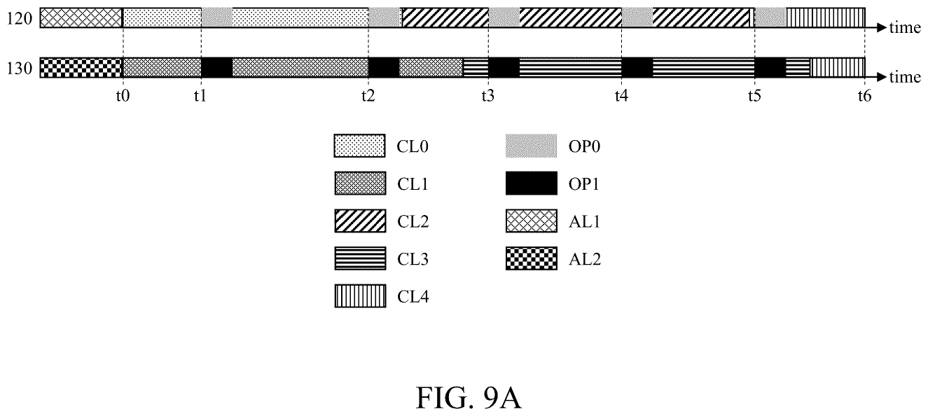

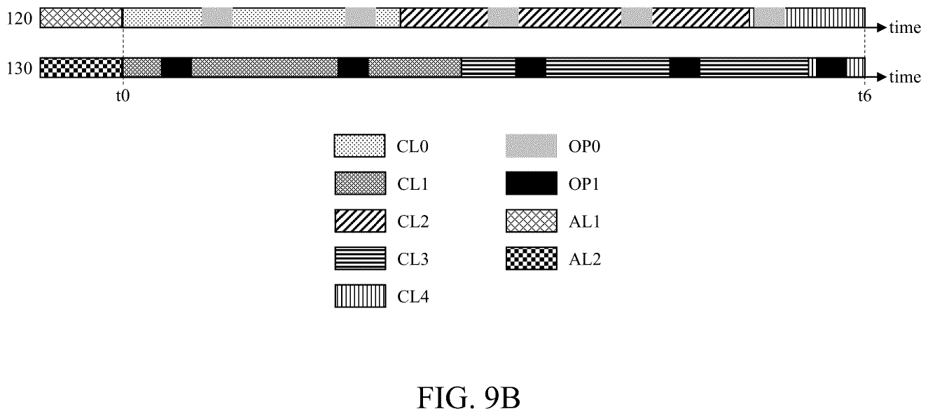

Reference is made to FIG. 9A, FIG. 9A is a schematic diagram of scanning channel according to another embodiment of the present invention. FIG. 9A may correspond to the process of FIG. 8. FIG. 9A illustrates the scenario of a multi-link multi-radio (MLMR), and it is assumed that the wireless communication circuit 100 has a total of 2 pairs of antennas, with the MAC circuit 120 (the first MAC circuit) and the MAC circuit 130 (the second MAC circuit) each using one pair of antennas (as shown in FIG. 1A). Before the time point t0, the control circuit 110 controls the MAC circuit 120 and the MAC circuit 130 to serve as the first active link AL1 and the second active link AL2, respectively (step S810, step S820). Between time point t0 and time point t6, the control circuit 110 controls the MAC circuit 120 and the MAC circuit 130 to perform scanning according to the processes in FIGS. 2A to 2C (step S830, step S840). In other words, the first channel list may be the channel list CL0, CL2, or CL4, and the second channel list may be the channel list CL1, CL3, or CL4.

However, because the MAC circuit 120 and the MAC circuit 130 are both active links, the control circuit 110 switches the MAC circuit 120 and the MAC circuit 130 to the operating channel (denoted as “OP0” and “OP1” respectively, steps S850 and S860) at specific time points (e.g., time points t1, t2, t3, t4, and t5) to avoid link interruption. Switching the MAC circuit to the operating channel is well known to people having ordinary skill in the art, so further elaboration is omitted for brevity.

Reference is made to FIG. 9B, which is a schematic diagram of scanning channel according to another embodiment of the present invention. FIG. 9B may correspond to the process of FIG. 8. FIG. 9B is similar to FIG. 9A, except that for FIG. 9B, the wireless communication circuit 100 operates in the Simultaneous Transmit and Receive multi-link multi-radio (STR-MLMR) mode, whereas for FIG. 9A, the wireless communication circuit 100 operates in the non-Simultaneous Transmit and Receive multi-link multi-radio (NSTR-MLMR) mode. Therefore, in FIG. 9A, the operating channel OP0 is aligned with the operating channel OP1, whereas in FIG. 9B, the operating channel OP0 and the operating channel OP1 do not necessarily occur simultaneously. The STR and the NSTR are well known to people having ordinary skill in the art, so further elaboration is omitted for brevity.

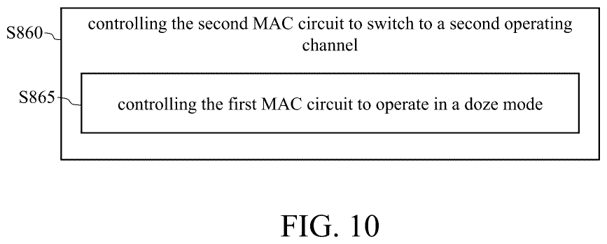

Reference is made to FIG. 10, which shows a sub-step S865 of step S860 in FIG. 8: the control circuit 110 controls the first MAC circuit to operate in a doze mode.

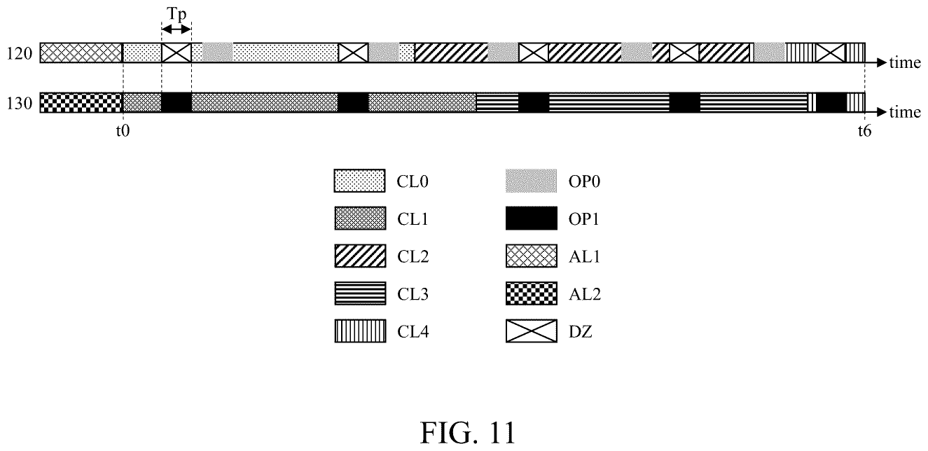

Reference is made to FIG. 11, which is a schematic diagram of scanning channel according to another embodiment of the present invention. FIG. 11 may correspond to the process of FIG. 8 and FIG. 10. FIG. 11 illustrates the scenario of non-multi-link operation (non-MLO), and it is assumed that the wireless communication circuit 100 has a total of 2 pairs of antennas. The MAC circuit 120 uses one pair of antennas for connection, the MAC circuit 130 uses two pairs of antennas for connection, but the MAC circuit 120 and the MAC circuit 130 both use one pair of antennas to scan. Between time point t0 and time point t6, the control circuit 110 controls the MAC circuit 120 and the MAC circuit 130 to perform scanning according to the processes in FIGS. 2A to 2C (step S830, step S840). Similar to the embodiment in FIG. 9B, the control circuit 110 switches the MAC circuit 120 and the MAC circuit 130 to the operating channel at specific time points to avoid link interruption. However, because the MAC circuit 130 uses two pairs of antennas for connection, resulting in the MAC circuit 120 having no antennas available during the periods (e.g., the period Tp) when the MAC circuit 130 switches to the operating channel OP1, the control circuit 110 must control the MAC circuit 120 to operate in the doze mode (denoted as “DZ”) during these periods. In some embodiments, in the doze mode DZ, the MAC circuit 120 does not transmit and/or receive any signals (i.e., does not establish a connection nor perform a scan).

In the context of non-MLO, if the MAC circuit 120 and the MAC circuit 130 each use one pair of antennas for connection, then the behavior of the MAC circuit 120 and the MAC circuit 130 is similar to FIG. 9B (where the doze mode DZ does not exist).

In summary, even if all the MAC circuits of the wireless communication circuit 100 are active links, the channel scanning mechanism of the present invention can use multiple active links to perform scanning simultaneously, which shortens the overall scan time and therefore allows the wireless communication circuit 100 to resume operation on the original active link as soon as possible. Therefore, the present invention can reduce power consumption and enhance the user experience.

In some embodiments, the control circuit 110 may be a circuit or electronic component with program execution capability, such as a microprocessor, a microcontroller, a central processing unit, or an equivalent circuit. The control circuit 110 executes the steps of FIGS. 2A to 2C, FIG. 4, FIG. 6, FIG. 8, and FIG. 10 by executing the program codes and/or program instructions stored in a memory (not shown). In an alternative embodiment, people having ordinary skill in the art can design the control circuit 110 based on the above discussion. That is to say, the control circuit 110 may be an application specific integrated circuit (ASIC) or can be embodied by circuitry or hardware such as a programmable logic device (PLD).

In other embodiments, the wireless communication circuit 100 may be a part of an electronic device (e.g., a mobile phone), and the control circuit 110 may refer to the software (e.g., a driver) or firmware executed by the processor of the electronic device.

Although the aforementioned embodiments use two MAC circuits and two pairs of antennas as an example, this is not a limitation of the present invention. People having ordinary skill in the art may apply the present invention to other numbers of the MAC circuits and the antennas in accordance with the foregoing discussions.

Although the aforementioned embodiments use the frequency bands of 2.4 GHz, 5 GHz, and 6 GHz as examples, this is not a limitation of the present invention. People having ordinary skill in the art may apply the present invention to other frequency bands in accordance with the foregoing discussions.

Since a person having ordinary skill in the art can appreciate the implementation detail and the modification thereto of the present method invention through the disclosure of the device invention, repeated and redundant description is thus omitted. Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A wireless communication circuit, comprising:
a plurality of pairs of antennas;
a first media access control (MAC) circuit;
a second MAC circuit;
a switch circuit coupled to the plurality of pairs of antennas, the first MAC circuit, and the second MAC circuit, and configured to couple the plurality of pairs of antennas to the first MAC circuit or the second MAC circuit; and
a control circuit coupled to the plurality of pairs of antennas, the first MAC circuit, the second MAC circuit, and the switch circuit, and configured to perform following steps:
controlling the first MAC circuit to scan a first channel list;
controlling the second MAC circuit to scan a second channel list; and
controlling the first MAC circuit to scan a third channel list after the first MAC circuit has scanned all channels in the first channel list.

2. The wireless communication circuit of claim 1, wherein the control circuit is further configured to perform following steps:
controlling the second MAC circuit to scan a fourth channel list after the second MAC circuit has scanned all channels in the second channel list.

3. The wireless communication circuit of claim 2, wherein the first MAC circuit scans the third channel list during a time period, and the second MAC circuit scans the fourth channel list during the time period.

4. The wireless communication circuit of claim 3, wherein the third channel list is equal to the fourth channel list.

5. The wireless communication circuit of claim 4, wherein the control circuit is further configured to perform following steps:
controlling the first MAC circuit and the second MAC circuit to end scanning after all channels in the third channel list have been scanned.

6. The wireless communication circuit of claim 4, wherein the first MAC circuit completes scanning at a first time point, the second MAC circuit completes scanning at a second time point, and a time difference between the first time point and the second time point is less than or equal to a period of time required for the first MAC circuit to scan a channel in the third channel list.

7. The wireless communication circuit of claim 2, wherein the frequency bands of the first channel list, the second channel list, the third channel list, and the fourth channel list are 2.4 GHz, 5 GHz, 6 GHz, and 5 GHz, respectively.

8. The wireless communication circuit of claim 2, wherein the control circuit is further configured to perform following steps:
controlling the first MAC circuit and the second MAC circuit to simultaneously scan a fifth channel list after all channels in the third channel list and the fourth channel list have been scanned.

9. The wireless communication circuit of claim 1, wherein the control circuit is further configured to perform following steps before controlling the first MAC circuit to scan the first channel list and controlling the second MAC circuit to scan the second channel list:
controlling the first MAC circuit to serve as a first active link; and
controlling the second MAC circuit to serve as a second active link.

10. The wireless communication circuit of claim 9, wherein the control circuit is further configured to perform following steps:
controlling the first MAC circuit to switch to a first operating channel at a first time point before scanning of the first channel list is completed; and
controlling the second MAC circuit to switch to a second operating channel at a second time point before scanning of the second channel list is completed.

11. The wireless communication circuit of claim 10, wherein the wireless communication circuit operates in a Simultaneous Transmit and Receive multi-link multi-radio (STR-MLMR) mode, and the first time point is equal to the second time point.

12. The wireless communication circuit of claim 10, wherein the wireless communication circuit operates in a non-Simultaneous Transmit and Receive multi-link multi-radio (NSTR-MLMR) mode.

13. The wireless communication circuit of claim 10, wherein the wireless communication circuit operates in a non-multi-link operation (non-MLO) mode, and the first MAC circuit and the second MAC circuit each use a pair of antennas for connection.

14. The wireless communication circuit of claim 10, wherein the wireless communication circuit operates in a non-multi-link operation (non-MLO) mode, and the second MAC circuit uses all the plurality of pairs of antennas to establish a connection, and the control circuit is further configured to perform following steps:
controlling the first MAC circuit to operate in a doze mode during a period of time when the second MAC circuit switches to the second operating channel.

15. The wireless communication circuit of claim 1, wherein the first MAC circuit and the second MAC circuit follow the Wi-Fi specification or the Bluetooth specification.

16. The wireless communication circuit of claim 1, wherein the first MAC circuit follows the Wi-Fi specification, and the second MAC circuit follows the Bluetooth specification.

17. A wireless communication circuit, comprising:
a plurality of pairs of antennas;
a first media access control (MAC) circuit;
a second MAC circuit;
a switch circuit coupled to the plurality of pairs of antennas, the first MAC circuit, and the second MAC circuit, and configured to couple the plurality of pairs of antennas to the first MAC circuit or the second MAC circuit; and
a control circuit coupled to the plurality of pairs of antennas, the first MAC circuit, the second MAC circuit, and the switch circuit, and configured to perform following steps:
controlling the first MAC circuit to serve as an active link; and
controlling the second MAC circuit to sequentially scan a first channel list, a second channel list, and a third channel list, wherein the first channel list and the second channel list are of a same frequency band, or the second channel list and the third channel list are of a same frequency band.

18. The wireless communication circuit of claim 17, wherein the control circuit is further configured to perform following steps:
controlling the second MAC circuit to scan a fourth channel list before scanning the first channel list;
wherein the frequency bands of the fourth channel list, the first channel list, the second channel list, and the third channel list are 2.4 GHz, 5 GHz, 5 GHz, and 6 GHz, respectively.

19. The wireless communication circuit of claim 18, wherein the control circuit is further configured to perform following steps:
controlling the second MAC circuit to scan a fifth channel list after completing scanning of the third channel list;
wherein a frequency band of the fifth channel list is 6 GHz.

20. The wireless communication circuit of claim 17, wherein the control circuit is further configured to perform following steps:
controlling the second MAC circuit to serve as the active link; and
controlling the first MAC circuit to take over scanning from the second MAC circuit.
